(19) United States
(12) Patent Application Publication
(10) Pub. No.: US 2014/0308107 A1
(43) Pub. Date: Oct. 16, 2014

(54) Last-in, first-out bottom-loading, bottom-deloading vertical storage and retrieval system and method of manufacture

(71) Applicant: Michael Nickles, Albuquerque, NM (US)

(72) Inventor: Michael Nickles, Albuquerque, NM (US)

(21) Appl. No.: 13/862,362

(22) Filed: Apr. 12, 2013

(51) Int. Cl. B65G 57/30

(52) U.S. Cl. CPC B65G 57/30
USPC 414/794.9; 29/418

(57) ABSTRACT

A last-in, first-out bottom-loading, bottom-deloading vertical storage and retrieval system comprising a raising and lowering means such as a jack or a leveraged arm, a frame with a pawl or pawls for supporting a tray, a plurality of trays, and a deloading means for disengaging the pawl or pawls that support a tray in the frame. A method of manufacture of the same.

### CROSS-REFERENCE TO RELATED APPLICATIONS

Not applicable.

### STATEMENTS REGARDING FEDERALLY SPONSORED RESEARCH AND DEVELOPMENT

Not applicable.

### BACKGROUND

The embodiments of the present invention satisfy the needs of having a better last-in, first-out bottom-loading, bottom-deloading vertical storage and retrieval system and method of manufacture.

Information relevant to attempts to address these problems can be found in U.S. Pat. Nos. 8,180,015; 8,118,178; 6,955,520; 6,199,857; 5,915,909; 5,452,821; 5,217,417; 4,120,407; 4,045,071; and U.S. Patent Application Nos. 20120076631; and 20040000260; which are not admitted to be prior art with respect to the present invention by its mention in this Background Section. However, it is desirable to have a better system and method than is disclosed in the references.

### SUMMARY

The embodiments of the present invention are directed to a system and method that satisfies the needs set out in the Background section.

The embodiments of the present invention comprise a last-in, first-out bottom-loading, bottom-deloading vertical storage and retrieval system, comprising a plurality of trays, a raising and lowering means such as a jack or a leveraged arm, a frame with pawls for engaging one tray at a time, and a deloading means for disengaging the pawls that support a tray in the frame. The embodiments of the present invention also comprise a method for manufacturing the system.

The embodiments of the invention can be understood to function like a toothed ratchet. The frame comprises a pawl or pawls, such as leveraged arms or spring-projected sliding latch bolts with cross pins, which suspend or support a bottom tray in air above the ground. The deloading means functions like an arm and catch in a toothed ratchet. The trays are stackable, and each tray functions like a tooth of a toothed ratchet.

Alternatively, the stack of trays can be understood to function like a ratchet column. The frame pawls in effect ratchet from one tray to the next; but it is the stack of trays that ratchets up and down, not the frame pawls. The frame pawls remain immobile, in the sense that one part of each of the frame pawls is fixedly attached to the frame.

A tray is loaded into the bottom of a frame by delivering the tray, for example on a rolling cart, robot, or a rolling step stool with spring-mounted casters; alternatively, the frames can be electrified and the rolling cart can run on an electric motor powered by engagement with the frame, much as an electric tram is powered by the transmission of electricity by connection with a bipolar overhead line. The tray is delivered to a space between the four legs of the frame, and then levering or jacking the tray upwards. In the case of the spring-projected sliding latch bolts, when the diagonal distal ends of the bolts engage the longitudinal slots in the corner post top ends, the bolts are thereby forced to retract against their springs and away from their original projecting positions, such that the tray corner post sides maintain the bolts in retracted positions while the tray continues to lift vertically past the bolts, and such that the bolts spring-project back to their original projecting positions when the tray corner post bottom ends are vertically lifted past the top of the bolt. Before the latch is engaged, the jack takes the weight off the sliding latch bolt in effect deloading it, allowing it to more readily retract and then re-project. The case of the leveraged arm is simpler. The upward moving tray simply deflects the leveraged arm, and once the tray clears the lever, the leveraged arm drops down to its original position.

In one embodiment, when the deloading means is levered or jacked up between the frame, it deloads the sliding latch bolts which enables the sliding latch bolt cross pins to move into and within a vertical looped track on the deloading means. As the deloading means is raised further, the looped track guides the cross pins so as to force the sliding latch bolts into retracted positions. This allows a tray to be lowered through the now-retracted sliding latch bolt which is acting a pawl. As the deloading means is lowered, a track pawl positioned at the bottom of the looped track prevents the cross pins from reversing and retracing their paths. Instead the cross pins continue their path along the looped track, which holds the pawls open and allows the tray to be lowered through them. When the cross pins reach the top of the looped track, the track guides them to allow the bolts to return to their original projecting positions.

To facilitate item location, the trays or even the items can be individually identified, e.g., through radio frequency identification (RFID) or through marking with computer readable optical media.

Items can also be loaded onto and unloaded from the top of the stack.

The embodiments of the invention comprise a last-in, first-out bottom-loading, bottom-deloading vertical storage and retrieval system, comprising:
a plurality of individually demountable stackable trays, each stackable tray comprising a tray height and a tray length and a tray width, each stackable tray comprising a means for securely stacking with other trays;
a frame adapted for surrounding four sides of one stackable tray, the frame comprising at least one vertical guiding sheet, each at least one vertical guiding sheet comprising an interior side facing an interior of the frame and comprising an opposing exterior side, each at least one vertical guiding sheet comprising a lateral edge and a medial edge, wherein each of the at least one vertical guiding sheet interior side comprises an elongated guide slot adapted for receiving a cross pin, the frame elevated by at least three frame legs to a height greater than one tray height, the frame comprising at least three frame pawls for engaging one stackable tray at a time such that a stack of trays is supported in air by the frame when the at least three frame pawls engage and support a bottom tray in the stack of trays, wherein each frame pawl comprises a cross pin;
a raising and lowering means for raising and lowering an item within the frame, wherein the raising and lowering means is operable for raising a single stackable tray between the at least three frame legs from a ground level to a position above the at least three frame pawls such that the single stackable tray is engaged and supported by the at least three frame pawls; and
a deloading means for disengaging the at least three frame pawls while the deloading means is being raised and lowered within the frame by the raising and lowering means, wherein the deloading means comprises at least one vertical looped track for receiving, guiding and releasing a cross pin as the deloading means is raised and lowered in the frame by the raising and lowering means, wherein each vertical looped track comprises a loop top and a loop bottom, wherein each vertical looped track comprises a loop pawl positioned at a loop bottom, wherein a top of the deloading means is adapted to stack with a bottom of a stackable tray such that the deloading means is operable for individually demounting a single stackable tray from a bottom of a stack of trays that are supported by the frame.

Optionally, the raising and lowering means is a jack selected from the group consisting of: a screw jack, an hydraulic jack, an electric jack, a ratchet jack, and a scissor jack.

Optionally, the raising and lowering means is a leveraged arm.

Optionally, the raising and lowering means is an electric linear actuator.

Optionally, each of the frame pawls comprises a levered arm, wherein each levered arm is positionable in a mortise in a medial edge of each of the at least one vertical guiding sheets, wherein a cross pin extends from a side of each levered arm.

Optionally, each elongated guide slot has a curvilinear shape.

Optionally, each of the frame pawls comprises a spring-projected sliding latch bolt, wherein each sliding latch bolt is slidably positionable in a mortise in a medial edge of each of the at least one vertical guiding sheets, wherein each sliding latch bolt has a diagonally-shaped distal end, wherein a cross pin extends from a side of each latch bolt.

Optionally, each elongated guide slot has a linear shape.

Optionally, each tray comprises four tray corners, wherein the means for securely stacking with other trays comprises four tray corner posts extending vertically from each tray corner, wherein each tray corner post comprises a tray corner post top end and a tray corner post bottom end and a tray corner post longitudinal axis, wherein each tray corner post top end comprises a tray corner post tongue monolithically extending along the tray corner post longitudinal axis, wherein each tray corner post tongue is adapted for fitting alongside a tray corner post bottom end of another tray so that trays can be securely stacked with other trays.

Optionally, each tray corner comprises a tray corner slot.

The embodiments of the invention further comprise a method for manufacturing a last-in, first-out bottom-loading, bottom-deloading vertical storage and retrieval system, comprising:
a. Providing a plurality of individually demountable stackable trays, each stackable tray comprising a tray height and a tray length and a tray width, each stackable tray comprising a means for securely stacking with other trays;
b. Providing a frame adapted for surrounding four sides of one stackable tray, the frame comprising at least one vertical guiding sheet, each at least one vertical guiding sheet comprising an interior side facing an interior of the frame and comprising an opposing exterior side, each at least one vertical guiding sheet comprising a lateral edge and a medial edge, wherein each of the at least one vertical guiding sheet interior side comprises an elongated guide slot adapted for receiving a cross pin, the frame elevated by at least three frame legs to a height greater than one tray height, the frame comprising at least three frame pawls for engaging one stackable tray at a time such that a stack of trays is supported in air by the frame when the at least three frame pawls engage and support a bottom tray in the stack of trays, wherein each frame pawl comprises a cross pin;
c. Providing a raising and lowering means for raising and lowering an item within the frame, wherein the raising and lowering means is operable for raising a single stackable tray between the at least three frame legs from a ground level to a position above the at least three frame pawls such that the single stackable tray is engaged and supported by the at least three frame pawls; and
d. Providing a deloading means for disengaging the at least three frame pawls while the deloading means is being raised and lowered within the frame by the raising and lowering means, wherein the deloading means comprises at least one vertical looped track for receiving, guiding and releasing a cross pin as the deloading means is raised and lowered in the frame by the raising and lowering means, wherein each vertical looped track comprises a loop top and a loop bottom, wherein each vertical looped track comprises a loop pawl positioned at a loop bottom, wherein a top of the deloading means is adapted to stack with a bottom of a stackable tray such that the deloading means is operable for individually demounting a single stackable tray from a bottom of a stack of trays that are supported by the frame.

The options enumerated above for the system also apply here to the method.

### Some Advantages of the Embodiments of the Invention

Storage and retrieval systems typically require high-rise storage frames and rows between frames. They typically utilize shelves rather than stackable trays. If they use stackable trays, either the entire stack must be removed to access any given tray, or the trays have to be removed from the top until the desired tray is reached. The embodiments of the present invention comprise stackable trays, which eliminate the need for towering frames in a facility. The single short frame is the only necessary shelf, as it functions as a loader and to stabilize the deloading function. The frame is approximately as tall as at least one tray and the loader and/or deloader. The embodiments of the present invention also eliminate the need for rows between frames, as the trays are usually but not exclusively loaded and unloaded from the bottom of the stack.

These and other advantages will become apparent as the embodiments of the invention are used.

### DRAWINGS

These and other features, aspects and advantages of the embodiments of the method will become better understood with reference to the following description, claims and accompanying drawings where:

FIG. 1 shows a perspective view of an embodiment of the invention, where a tray is positioned below a stack of trays; the loader can be other than a jack and the legs can be other than I-beams;

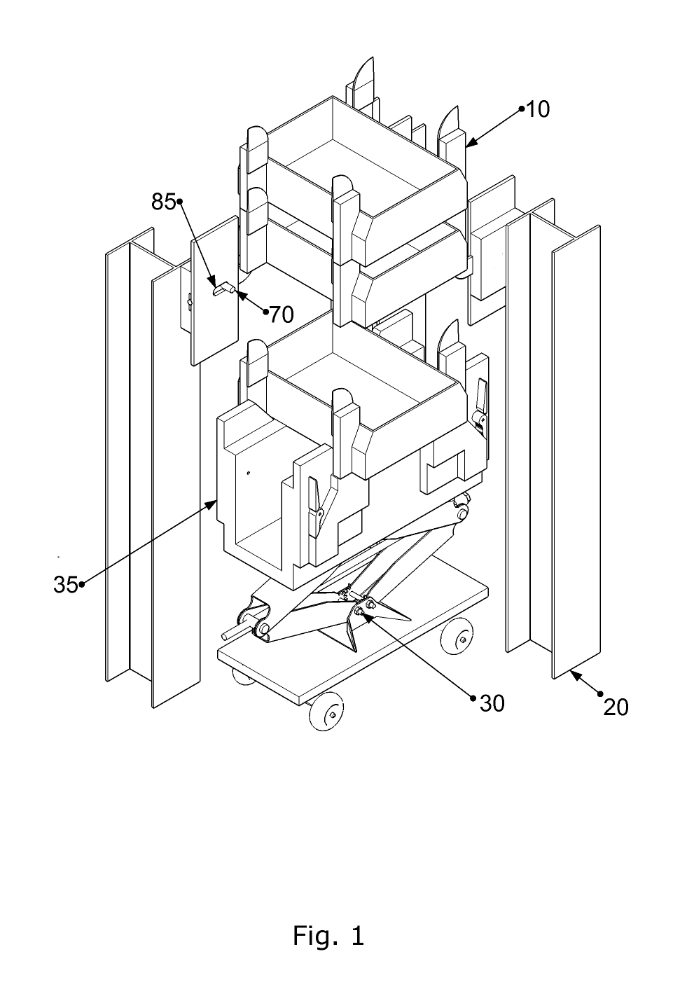

FIG. 2 shows a perspective view of a frame;

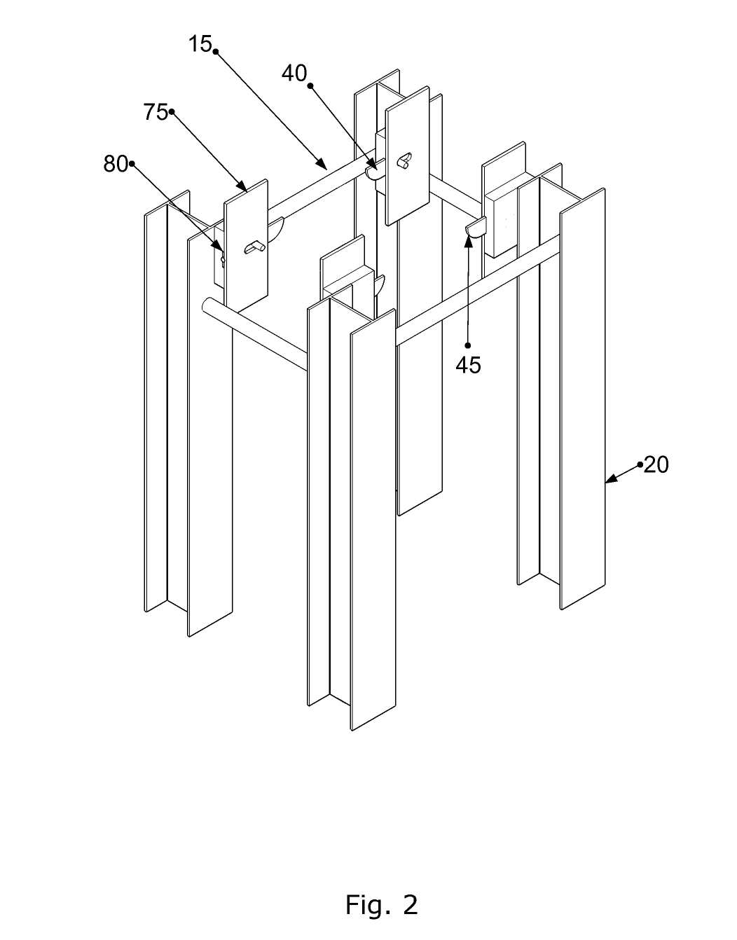

FIG. 3 shows a perspective view of a tray;

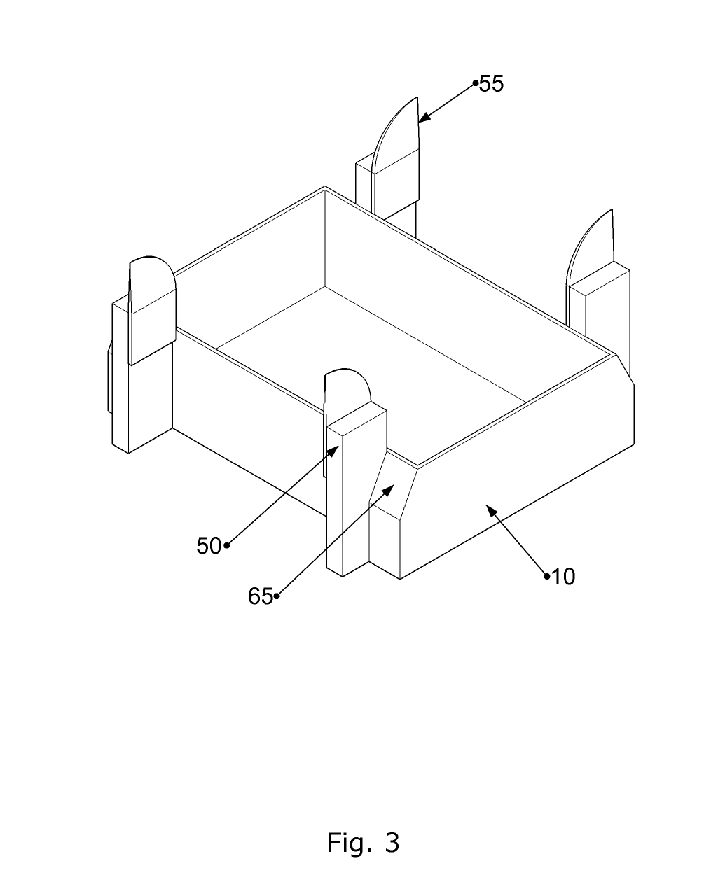

FIG. 4 shows a perspective view of a deloader.

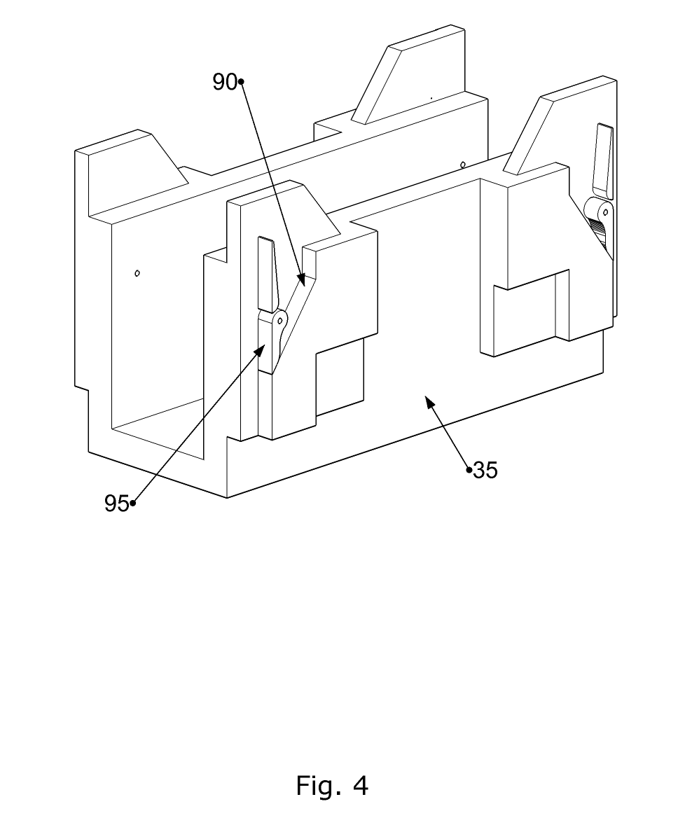

### REFERENCE NUMERALS FOR DRAWINGS

10 Tray
15 Frame
20 Frame leg
30 Raising and lowering means
35 Deloading means
40 Sliding latch bolt
45 Sliding latch bolt diagonally-shaped distal end
50 Tray corner post
55 Tray corner post tongue
65 Diagonal portion of a tray corner slot
70 Cross pin
75 Vertical guiding sheet
85 Horizontal elongated guide slot
90 Vertical looped track
95 Loop pawl

### DESCRIPTION

Definitions

A standard toothed ratchet comprises an arm and catch, a pawl, and at least one tooth.

### Description of the Preferred Embodiment and Best Mode

As shown in the figures, the preferred embodiment and best mode of the present invention comprise a last-in, first-out bottom-loading, bottom-deloading vertical storage and retrieval system, comprising:
a plurality of individually demountable stackable trays 10, each stackable tray 10 comprising a tray height and a tray length and a tray width, each stackable tray 10 comprising a means for securely stacking with other trays 10;
a frame 15 adapted for surrounding four sides of one stackable tray 10, the frame 15 comprising at least one vertical guiding sheet 75, each at least one vertical guiding sheet 75 comprising an interior side facing an interior of the frame 15 and comprising an opposing exterior side, each at least one vertical guiding sheet 75 comprising a lateral edge and a medial edge, wherein each of the at least one vertical guiding sheet 75 interior side comprises an elongated guide slot 85 adapted for receiving a cross pin 70, the frame 15 elevated by at least three frame legs 20 to a height greater than one tray height, the frame 15 comprising at least three frame pawls 40 for engaging one stackable tray 10 at a time such that a stack of trays 10 is supported in air by the frame 15 when the at least three frame pawls 40 engage and support a bottom tray 10 in the stack of trays 10, wherein each frame pawl comprises a cross pin 70;
a raising and lowering means 30 for raising and lowering an item within the frame 15, wherein the raising and lowering means is operable for raising a single stackable tray 10 between the at least three frame legs 20 from a ground level to a position above the at least three frame pawls 40 such that the single stackable tray 10 is engaged and supported by the at least three frame pawls 40; and
a deloading means 35 for disengaging the at least three frame pawls 40 while the deloading means 35 is being raised and lowered within the frame by the raising and lowering means, wherein the deloading means 35 comprises at least one vertical looped track 90 for receiving, guiding and releasing a cross pin as the deloading means 35 is raised and lowered in the frame by the raising and lowering means, wherein each vertical looped track 90 comprises a loop top and a loop bottom, wherein each vertical looped track 90 comprises a loop pawl 95 positioned at a loop bottom, wherein a top of the deloading means 35 is adapted to stack with a bottom of a stackable tray 10 such that the deloading means 35 is operable for individually demounting a single stackable tray 10 from a bottom of a stack of trays 10 that are supported by the frame 15.

Optionally, the raising and lowering means 30 is a jack selected from the group consisting of: a screw jack, an hydraulic jack, an electric jack, a ratchet jack, and a scissor jack.

Optionally, the raising and lowering means 30 is a leveraged arm.

Optionally, the raising and lowering means 30 is an electric linear actuator.

Optionally, each of the frame pawls 40 comprises a levered arm, wherein each levered arm is positionable in a mortise in a medial edge of each of the at least one vertical guiding sheets, wherein a cross pin 70 extends from a side of each levered arm.

Optionally, each elongated guide slot 85 has a curvilinear shape.

Optionally, each of the frame pawls 40 comprises a spring-projected sliding latch bolt, wherein each sliding latch bolt is slidably positionable in a mortise in a medial edge of each of the at least one vertical guiding sheets, wherein each sliding latch bolt has a diagonally-shaped distal end 45, wherein a cross pin 70 extends from a side of each latch bolt.

Optionally, each elongated guide slot 85 has a linear shape.

Optionally, each tray 10 comprises four tray corners, wherein the means for securely stacking with other trays 10 comprises four tray corner posts 50 extending vertically from each tray corner, wherein each tray corner post 50 comprises a tray corner post top end and a tray corner post bottom end and a tray corner post longitudinal axis, wherein each tray corner post top end comprises a tray corner post tongue 55 monolithically extending along the tray corner post longitudinal axis, wherein each tray corner post tongue 55 is adapted for fitting alongside a tray corner post bottom end of another tray 10 so that trays 10 can be securely stacked with other trays 10.

Optionally, each tray corner comprises a tray corner slot 65.

Some advantages of the embodiments of the apparatus were previously enumerated in the Summary section. Every advantageous feature does not need to be incorporated into every embodiment of the apparatus and/or methods.

Although these versions of the invention have been described in considerable detail, other versions are possible. For example, embodiments can comprise combinations of the features described herein, such as combinations of the dependent claims. Therefore, the spirit and scope of the appended claims should not be limited to the description of the versions contained therein.

I claim:

1. A last-in, first-out bottom-loading, bottom-deloading vertical storage and retrieval system, comprising:
a plurality of individually demountable stackable trays, each stackable tray comprising a tray height and a tray length and a tray width, each stackable tray comprising a means for securely stacking with other trays;
a frame adapted for surrounding four sides of one stackable tray, the frame comprising at least one vertical guiding sheet, each at least one vertical guiding sheet comprising an interior side facing an interior of the frame and comprising an opposing exterior side, each at least one vertical guiding sheet comprising a lateral edge and a medial edge, wherein each of the at least one vertical guiding sheet interior side comprises an elongated guide slot adapted for receiving a cross pin, the frame elevated by at least three frame legs to a height greater than one tray height, the frame comprising at least three frame pawls for engaging one stackable tray at a time such that a stack of trays is supported in air by the frame when the at least three frame pawls engage and support a bottom tray in the stack of trays, wherein each frame pawl comprises a cross pin;
a raising and lowering means for raising and lowering an item within the frame, wherein the raising and lowering means is operable for raising a single stackable tray between the at least three frame legs from a ground level to a position above the at least three frame pawls such that the single stackable tray is engaged and supported by the at least three frame pawls; and
a deloading means for disengaging the at least three frame pawls while the deloading means is being raised and lowered within the frame by the raising and lowering means, wherein the deloading means comprises at least one vertical looped track for receiving, guiding and releasing a cross pin as the deloading means is raised and lowered in the frame by the raising and lowering means, wherein each vertical looped track comprises a loop top and a loop bottom, wherein each vertical looped track comprises a loop pawl positioned at a loop bottom, wherein a top of the deloading means is adapted to stack with a bottom of a stackable tray such that the deloading means is operable for individually demounting a single stackable tray from a bottom of a stack of trays that are supported by the frame.

2. The system of claim 1, wherein the raising and lowering means is a jack selected from the group consisting of: a screw jack, an hydraulic jack, an electric jack, a ratchet jack, and a scissor jack.

3. The system of claim 1, wherein the raising and lowering means is a leveraged arm.

4. The system of claim 1, wherein the raising and lowering means is an electric linear actuator.

5. The system of claim 1, wherein each of the frame pawls comprises a levered arm, wherein each levered arm is positionable in a mortise in a medial edge of each of the at least one vertical guiding sheets, wherein a cross pin extends from a side of each levered arm.

6. The system of claim 5, wherein each elongated guide slot has a curvilinear shape.

7. The system of claim 1, wherein each of the frame pawls comprises a spring-projected sliding latch bolt, wherein each sliding latch bolt is slidably positionable in a mortise in a medial edge of each of the at least one vertical guiding sheets, wherein each sliding latch bolt has a diagonally-shaped distal end, wherein a cross pin extends from a side of each latch bolt.

8. The system of claim 7, wherein each elongated guide slot has a linear shape.

9. The system of claim 1, wherein each tray comprises four tray corners, wherein the means for securely stacking with other trays comprises four tray corner posts extending vertically from each tray corner, wherein each tray corner post comprises a tray corner post top end and a tray corner post bottom end and a tray corner post longitudinal axis, wherein each tray corner post top end comprises a tray corner post tongue monolithically extending along the tray corner post longitudinal axis, wherein each tray corner post tongue is adapted for fitting alongside a tray corner post bottom end of another tray so that trays can be securely stacked with other trays.

10. The system of claim 9, wherein each tray corner comprises a tray corner slot.

11. A method for manufacturing a last-in, first-out bottom-loading, bottom-deloading vertical storage and retrieval system, comprising:
a. Providing a plurality of individually demountable stackable trays, each stackable tray comprising a tray height and a tray length and a tray width, each stackable tray comprising a means for securely stacking with other trays;
b. Providing a frame adapted for surrounding four sides of one stackable tray, the frame comprising at least one vertical guiding sheet, each at least one vertical guiding sheet comprising an interior side facing an interior of the frame and comprising an opposing exterior side, each at least one vertical guiding sheet comprising a lateral edge and a medial edge, wherein each of the at least one vertical guiding sheet interior side comprises an elongated guide slot adapted for receiving a cross pin, the frame elevated by at least three frame legs to a height greater than one tray height, the frame comprising at least three frame pawls for engaging one stackable tray at a time such that a stack of trays is supported in air by the frame when the at least three frame pawls engage and support a bottom tray in the stack of trays, wherein each frame pawl comprises a cross pin;
c. Providing a raising and lowering means for raising and lowering an item within the frame, wherein the raising and lowering means is operable for raising a single stackable tray between the at least three frame legs from a ground level to a position above the at least three frame pawls such that the single stackable tray is engaged and supported by the at least three frame pawls; and
d. Providing a deloading means for disengaging the at least three frame pawls while the deloading means is being raised and lowered within the frame by the raising and lowering means, wherein the deloading means comprises at least one vertical looped track for receiving, guiding and releasing a cross pin as the deloading means is raised and lowered in the frame by the raising and lowering means, wherein each vertical looped track comprises a loop top and a loop bottom, wherein each vertical looped track comprises a loop pawl positioned at a loop bottom, wherein a top of the deloading means is adapted to stack with a bottom of a stackable tray such that the deloading means is operable for individually demounting a single stackable tray from a bottom of a stack of trays that are supported by the frame.

12. The method of claim 11, wherein the raising and lowering means is a jack selected from the group consisting of: a screw jack, an hydraulic jack, an electric jack, a ratchet jack, and a scissor jack.

13. The method of claim 1, wherein the raising and lowering means is a leveraged arm.

14. The method of claim 11, wherein the raising and lowering means is an electric linear actuator.

15. The method of claim 11, wherein each of the frame pawls comprises a levered arm, wherein each levered arm is positionable in a mortise in a medial edge of each of the at least one vertical guiding sheets, wherein a cross pin extends from a side of each levered arm.

16. The method of claim 15, wherein each elongated guide slot has a curvilinear shape.

17. The method of claim 11, wherein each of the frame pawls comprises a spring-projected sliding latch bolt, wherein each sliding latch bolt is slidably positionable in a mortise in a medial edge of each of the at least one vertical guiding sheets, wherein each sliding latch bolt has a diagonally-shaped distal end, wherein a cross pin extends from a side of each latch bolt.

18. The method of claim 17, wherein each elongated guide slot has a linear shape.

19. The method of claim 11, wherein each tray comprises four tray corners, wherein the means for securely stacking with other trays comprises four tray corner posts extending vertically from each tray corner, wherein each tray corner post comprises a tray corner post top end and a tray corner post bottom end and a tray corner post longitudinal axis, wherein each tray corner post top end comprises a tray corner post tongue monolithically extending along the tray corner post longitudinal axis, wherein each tray corner post tongue is adapted for fitting alongside a tray corner post bottom end of another tray so that trays can be securely stacked with other trays.

20. The method of claim 19, wherein each tray corner comprises a tray corner slot.
